(19) United States
(12) Patent Application Publication
(10) Pub. No.: US 2022/0379795 A1
(43) Pub. Date: Dec. 1, 2022

(54) AIR CONDITIONING SYSTEM

(71) Applicant: DENSO CORPORATION, Kariya-city (JP)

(72) Inventor: Nobuyuki ENOMOTO, Kariya-city (JP)

(21) Appl. No.: 17/884,094

(22) Filed: Aug. 9, 2022

Related U.S. Application Data
(63) Continuation of application No. PCT/JP2020/048188, filed on Dec. 23, 2020.

(30) Foreign Application Priority Data
Feb. 12, 2020 (JP) 2020-021747

(51) Int. Cl. B60P 3/20; F24F 11/72; F25D 11/00

(52) U.S. Cl. CPC B60P 3/20; F24F 11/72; F25D 11/003; F25D 2400/12

(57) ABSTRACT

An air conditioning system includes an air conditioner mounted on a mobile body having a cold storage. The air conditioner includes a compressor, a condenser, a decompression device, an evaporator, and a blower. The air conditioning system includes a charge display device configured to display a charge related to a use of the air conditioner; and a controller configured to control an air conditioning operation. The controller includes: a load calculation unit that calculates an air conditioning load of the air conditioner; a charge calculation unit that calculates a usage charge based on the air conditioning load; and a charge display unit that displays the usage charge on the charge display device.

### CROSS REFERENCE TO RELATED APPLICATION

The present application is a continuation application of International Patent Application No. PCT/JP2020/048188 filed on Dec. 23, 2020, which designated the U.S. and claims the benefit of priority from Japanese Patent Application No. 2020-21747 filed on Feb. 12, 2020. The entire disclosures of all of the above applications are incorporated herein by reference.

### TECHNICAL FIELD

The present disclosure relates to an air conditioning system.

### BACKGROUND

A vehicle has a freezer luggage compartment on a vehicle body. A temperature in the freezer luggage compartment is automatically controlled to be the set temperature.

### SUMMARY

According to an aspect of the present disclosure, an air conditioning system includes: an air conditioner mounted on a mobile body having a cold storage, the air conditioner including a compressor, a condenser, a decompression device, an evaporator, and a blower; a charge display device configured to display a charge related to a use of the air conditioner; and a controller configured to control an air conditioning operation. The controller includes: a load calculation unit that calculates an air conditioning load of the air conditioner; a charge calculation unit that calculates a usage charge based on the air conditioning load; and a charge display unit that displays the usage charge on the charge display device.

### BRIEF DESCRIPTION OF DRAWING

FIG. 1 is a perspective view showing a schematic configuration of a vehicle provided with a cold storage.

FIG. 2 is a cross-sectional view showing a schematic configuration of the cold storage and an air conditioner.

FIG. 3 is a configuration diagram showing an operation panel.

FIG. 4 is a configuration diagram showing a display device.

FIG. 5 is a block diagram relating to a control of an air conditioning system.

FIG. 6 is a graph showing changes in outside air temperature and refrigerator inside temperature over time.

FIG. 7 is a flowchart relating to a control of an air conditioning system.

FIG. 8 is a flowchart relating to a process of step S110 of FIG. 7.

FIG. 9 is a graph relating to a process of step S153 of FIG. 7.

FIG. 10 is a flowchart relating to a control of an air conditioning system according to a second embodiment.

FIG. 11 is a graph relating to a process of step S153 of FIG. 10.

FIG. 12 is a block diagram relating to a control of an air conditioning system according to a third embodiment.

FIG. 13 is a flowchart relating to a control of an air conditioning system according to the third embodiment.

### DETAILED DESCRIPTION

To begin with, examples of relevant techniques will be described.

A vehicle has a freezer luggage compartment on a vehicle body in JP H05-89035 U, the disclosures of which are incorporated herein by reference to explain technical elements presented herein.

In the structure of the disclosures, the temperature in the freezer luggage compartment is automatically controlled to be the set temperature. At this time, the amount of the refrigerant to be supplied to the evaporator differs depending on the conditions such as the set temperature. The amount of energy consumed by the air conditioning system differs depending on the amount of the refrigerant supplied to the evaporator. It is difficult for a user who use the air conditioning system, such as occupant of the vehicle, to obtain information such as the drive time and rotation speed of the automatically controlled compressor, while the air conditioning system is operated, so as to evaluate the air conditioning system for controlling the temperature. Further improvements are required in the air conditioning system in the above-mentioned viewpoints or in other viewpoints not mentioned.

The present disclosure provides an air conditioning system capable of letting the user know the usage charge according to the usage record.

An air conditioning system includes an air conditioner mounted on a mobile body having a cold storage, and the air conditioner includes a compressor, a condenser, a decompression device, an evaporator, and a blower. The air conditioning system includes a charge display device configured to display a charge related to a use of the air conditioner; and a controller configured to control an air conditioning operation. The controller includes: a load calculation unit that calculates an air conditioning load of the air conditioner; a charge calculation unit that calculates a usage charge based on the air conditioning load; and a charge display unit that displays the usage charge on the charge display device.

The controller includes the load calculation unit that calculates the air conditioning load of the air conditioner, the charge calculation unit that calculates the usage charge based on the calculated air conditioning load, and the charge display unit that displays the calculated usage charge on the charge display device. Therefore, the charge display unit can display the usage charge based on the usage record of the air conditioner. Thus, it is possible to provide an air conditioning system that can let the user know the usage charge according to the usage record.

The disclosed aspects in this specification adopt different technical solutions from each other in order to achieve their respective objectives. Reference numerals exemplarily show corresponding relationships with parts of embodiments to be described later and are not intended to limit technical scopes. The objects, features, and advantages disclosed in this specification will become apparent by referring to following detailed descriptions and accompanying drawings.

Hereinafter, embodiments are described with reference to the drawings. In some embodiments, functionally and/or structurally corresponding and/or associated parts may be given the same reference numerals, or reference numerals with different digit placed on equal to or higher than a hundred place. The description of other embodiments can be referred to for corresponding parts and/or associated parts.

### First Embodiment

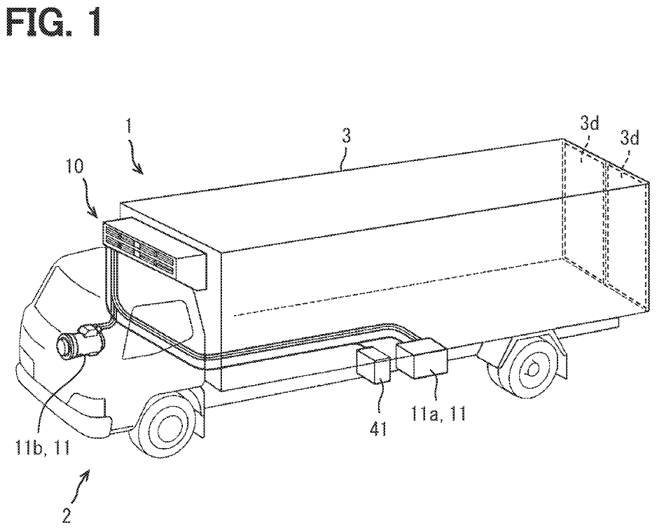

In FIG. 1, a vehicle 2 is a mobile body called a freezer car, a refrigerator car, or the like equipped with a cold storage (refrigerator) 3. The cold storage 3 is made of a heat insulating panel having high heat insulating performance in order to reduce heat exchange with the outside. The object to be cooled is stored inside the cold storage 3, and the object to be cooled is transported to the destination at a low temperature together with the cold storage 3. The vehicle 2 can be used for transporting various objects to be cooled that require low temperature transport. The vehicle 2 can be used, for example, for low-temperature transportation of pharmaceutical products that require precise temperature control. The vehicle 2 can be used, for example, for low-temperature transportation of agricultural products and livestock products that are required to maintain a refrigerated temperature. The vehicle 2 can be used, for example, for low-temperature transportation of frozen foods that are required to maintain a freezing temperature. The vehicle 2 provides an example of a mobile body.

The temperature inside the cold storage 3 is controlled by the air conditioner 10 so that the temperature inside the cold storage 3 is maintained near the set temperature. The compressor 11 of the air conditioner 10 includes an electric compressor 11a and an engine driven compressor 11b. The electric compressor 11a is driven by being supplied with electric power from the power supply control unit 41. The engine driven compressor 11b is driven by obtaining power from the engine used for traveling the vehicle 2. However, the compressor 11 may be configured as either the electric compressor 11a or the engine driven compressor 11b. Further, the compressor 11 may be configured to include another compressor in addition to the electric compressor 11a and the engine driven compressor 11b. The electric compressor 11a provides an example of an electric component.

The cold storage 3 has a cold storage door 3d for switching communication between the inside and the outside of the cold storage 3. The cold storage door 3d opens and closes in a double-door manner in the left and right direction. The cold storage door 3d is provided on the side opposite to the position where the air conditioner 10 is installed in the cold storage 3. Therefore, the inside of the cold storage 3 has a front portion close to the air conditioner 10 and a rear portion close to the cold storage door 3d. In the cold storage 3, it is possible to create a temperature difference between the front portion and the rear portion of the cold storage 3 by partitioning the inside of the cold storage 3 front and rear using a curtain.

The air conditioner 10 is attachable to and removable from the vehicle 2. Therefore, the air conditioner 10 can be attached to a truck that does not have the air conditioner 10 later to make a freezer truck or a refrigerator truck. Alternatively, the air conditioner 10 can be removed from the freezer truck equipped with the air conditioner 10 to make a truck without the air conditioner 10. Alternatively, the refrigerator vehicle can be changed to a freezer vehicle by using the air conditioner 10 having a higher cooling capacity. Further, an owner of a truck not equipped with the air conditioner 10 can obtain a refrigerator vehicle or a freezer vehicle at a relatively low introduction cost by leasing the air conditioner 10.

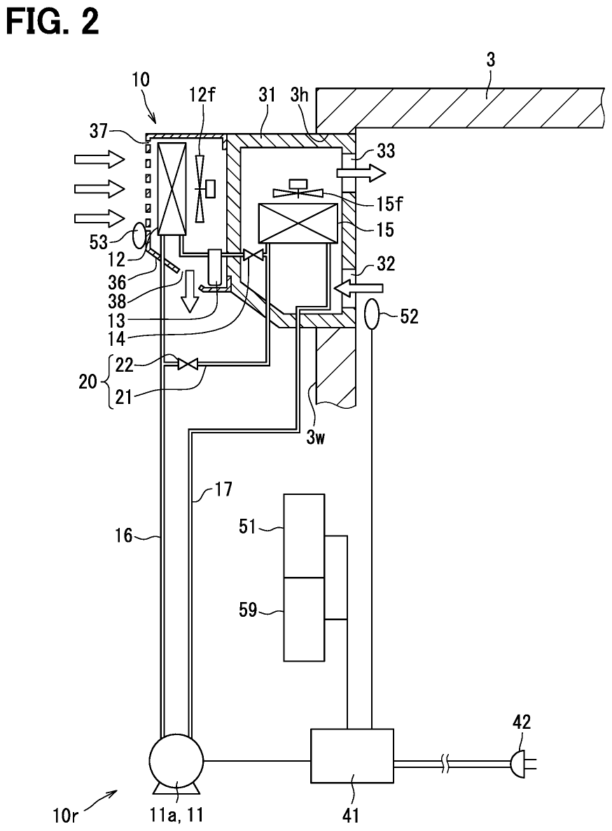

FIG. 2 is a cross-sectional view showing the vicinity of the air conditioner 10 when the electric compressor 11a is used as the compressor 11 of the refrigeration cycle device 10r. When the engine driven compressor 11b is used as the compressor 11, power is supplied from the engine to the engine driven compressor 11b instead of the power supply control unit 41 to drive the compressor 11.

The air conditioner 10 includes the refrigeration cycle device 10r having the compressor 11, a condenser 12, an expansion valve 14, and an evaporator 15. The compressor 11 compresses the gas phase refrigerant to bring the gas phase refrigerant into a high temperature and high pressure state. The condenser 12 lowers the temperature of the gas phase refrigerant compressed by the compressor 11 to condense into the liquid phase refrigerant. The condenser 12 is a heat exchanger that heats the surrounding air by exchanging heat between the refrigerant and the surrounding air.

The expansion valve 14 expands the liquid phase refrigerant condensed by the condenser 12 to lower the temperature and pressure such that the liquid phase refrigerant is easily evaporated. Instead of the variable throttle valve such as the expansion valve 14, a fixed throttle such as a capillary tube or an orifice may be used to reduce the pressure of the refrigerant. The expansion valve 14 provides an example of a decompressing device. The evaporator 15 evaporates the liquid phase refrigerant expanded by the expansion valve 14. The evaporator 15 is a heat exchanger that cools the surrounding air by exchanging heat between the refrigerant and the surrounding air.

The refrigeration cycle device 1 Or includes a high-pressure pipe 16 that connects the compressor 11 to the condenser 12 and the expansion valve 14 to form a flow path for the refrigerant. A high-pressure refrigerant that has been compressed by the compressor 11 and to be decompressed by the expansion valve 14 flows through the high-pressure pipe 16. The refrigeration cycle device 10r includes a low-pressure pipe 17 that connects the expansion valve 14 to the evaporator 15 and the compressor 11 to form a flow path for the refrigerant. A low-pressure refrigerant that has been decompressed by the expansion valve 14 and to be compressed by the compressor 11 flows through the low-pressure pipe 17. The high-pressure pipe 16 and the low-pressure pipe 17 form an annular flow path for the refrigerant.

A liquid receiver 13 is provided between the condenser 12 and the expansion valve 14 in the high-pressure pipe 16. The liquid receiver 13 separates the gas phase refrigerant and the liquid phase refrigerant from each other. Therefore, only the liquid phase refrigerant flows through the expansion valve 14 located downstream of the liquid receiver 13 in the refrigerant flow.

The air conditioner 10 includes an evaporator case 31 that partitions the evaporator 15, which becomes low temperature when the compressor 11 is driven, from the surroundings. The evaporator case 31 is made of a heat insulating panel having high heat insulating performance. The evaporator case 31 is fitted and fixed to the opening 3h provided in the upper part of the front wall 3w of the cold storage 3. The expansion valve 14 is located inside the evaporator case 31.

An evaporator fan 15f is provided inside the evaporator case 31. The evaporator fan 15f facilitates heat exchange by flowing air around the evaporator 15. The evaporator case 31 has an inside air suction port 32 and an inside air outlet 33. The inside air suction port 32 and the inside air outlet 33 communicate with each other between the inside of the evaporator case 31 and the inside of the cold storage 3. When the evaporator fan 15f is rotating, the inside air, which is the air inside the cold storage 3, is sucked into the evaporator case 31 from the inside air suction port 32. When the evaporator fan 15f is rotating, the air inside the evaporator case 31 is blown out from the inside air outlet 33 into the cold storage 3. The evaporator fan 15f has a function of blowing cold air after heat exchange with the evaporator 15 into the cold storage 3. The evaporator fan 15f provides an example of a blower of an air conditioner. The evaporator fan 15f provides an example of an electric component.

The air conditioner 10 includes a condenser case 36 that partitions the condenser 12 that becomes hot when the compressor 11 is driven from the surroundings. The condenser case 36 is provided adjacent to the evaporator case 31 and in front of the evaporator case 31. In other words, the condenser case 36 is provided on the surface of the evaporator case 31 opposite to the surface communicating with the inside of the cold storage 3.

The condenser fan 12f is provided inside the condenser case 36. The condenser fan 12f facilitates heat exchange by flowing air around the condenser 12. The condenser case 36 has an outside air suction port 37 and an outside air outlet 38. The outside air suction port 37 and the outside air outlet 38 communicate the inside of the condenser case 36 with the outside space. When the condenser fan 12f is rotating, the outside air, which is the air in the external space, is sucked into the condenser case 36 from the outside air suction port 37. When the condenser fan 12f is rotating, the air inside the condenser case 36 is blown out from the outside air outlet 38 to the outside space. The outside air suction port 37 functions as a suction port for sucking air flowing in the direction opposite to the traveling direction of the vehicle 2 into the condenser case 36 while the vehicle 2 is traveling. The condenser fan 12f provides an example of an air conditioner blower. The condenser fan 12f provides an example of an electric component.

The air conditioner 10 includes a defrosting device 20 for defrosting the evaporator 15. The defrosting device 20 includes a hot gas pipe 21 and a hot gas valve 22. The hot gas pipe 21 connects the high pressure pipe 16 and the evaporator 15 and guides the high temperature and high pressure gas phase refrigerant before flowing through the condenser 12 to the inside of the evaporator 15. The hot gas valve 22 is a valve device for adjusting the flow rate of the refrigerant that can flow through the hot gas pipe 21. The hot gas valve 22 is a solenoid valve whose opening degree can be electrically adjusted.

By driving the compressor 11 with the hot gas valve 22 open, a high-temperature and high-pressure gas refrigerant can flow through the evaporator 15. As a result, the frost generated on the surface of the evaporator 15 can be melted and defrosted. When defrosting is not required, the hot gas valve 22 is closed to shut off the flow of the refrigerant in the hot gas pipe 21. As a result, the low-temperature low-pressure liquid-phase refrigerant that has passed through the condenser 12 and the expansion valve 14 can flow through the evaporator 15. In other words, by controlling the opening degree of the hot gas valve 22, the evaporator 15 can be switched between a high temperature state and a low temperature state.

The defrosting device 20 is not limited to the above configuration in which the hot gas pipe 21 and the hot gas valve 22 are used to flow a high temperature and high pressure gas phase refrigerant to the evaporator 15. As the defrosting device 20, for example, an electric heater provided in the vicinity of the evaporator 15 can be adopted. In this case, it is easier to design the defrosting device 20 to be smaller than when the hot gas pipe 21 or the hot gas valve 22 is used. In addition, the defrosting ability can be adjusted by controlling the output of the electric heater. Therefore, it is easy to shorten the time required for defrosting as compared with the case where the hot gas pipe 21 and the hot gas valve 22 are used. As the defrosting method, the two methods, e.g., the method using the hot gas and the method using the electric heater, or another defrosting method may be used in combination.

The air conditioner 10 includes the power supply control unit 41 and the power cable 42. The power supply control unit 41 controls the electric power supplied to the vehicle 2 and the air conditioner 10. The power cable 42 receives power supply from an external power source. The power cable 42 is connectable to a commercial AC power supply. The power supply control unit 41 has a function of converting AC power supplied by using the power cable 42 into DC power. The power supply control unit 41 has a function of stepping up or stepping down the magnitude of the supplied voltage to convert it into a desired voltage.

The air conditioner 10 includes an operation panel 51, a refrigerator inside temperature sensor 52, an outside temperature sensor 53, and an occupant display device 59. The refrigerator inside temperature sensor 52 measures an internal temperature, which is a temperature inside the cold storage 3 (refrigerator). The refrigerator inside temperature sensor 52 is provided in the vicinity of the inside air suction port 32. The installation position and number of the refrigerator inside temperature sensors 52 are not limited to the above example. For example, plural refrigerator inside temperature sensors 52 may be provided at two locations, a front portion and a rear portion of the cold storage 3, to measure plural internal temperatures.

The outside temperature sensor 53 measures the outside air temperature, which is the temperature of the external space. The outside temperature sensor 53 is provided in the vicinity of the outside air suction port 37. The installation position and number of the outside temperature sensors 53 are not limited to the above example. For example, plural outside temperature sensors 53 may be provided, and the average value of the temperatures measured by the outside temperature sensors 53 may be used as the outside air temperature. In this case, even if one outside temperature sensor 53 cannot appropriately measure the temperature, the remaining outside temperature sensor 53 can be used to measure the outside air temperature.

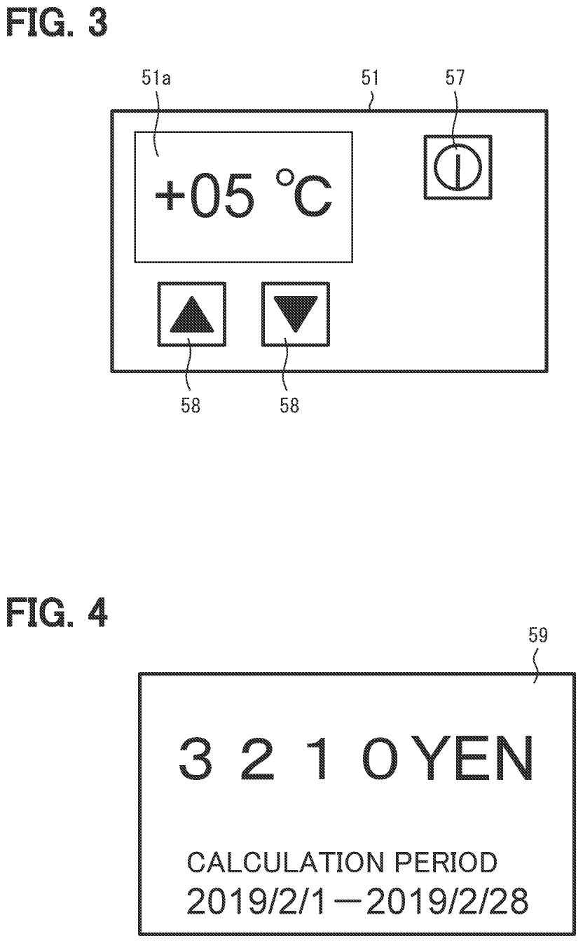

The operation panel 51 is used for the occupant to set a set temperature, an air volume, and the like in the air conditioning operation. In FIG. 3, the operation panel 51 is provided with a display screen 51a, a power button 57, and a setting change button 58. The display screen 51a displays information related to the air conditioning operation such as the set temperature. On the display screen 51a, information such as a set air volume and a set humidity can be displayed as information set by the occupant in addition to the set temperature. Information such as the current temperature inside the refrigerator and the current humidity inside the refrigerator can be displayed on the display screen 51a as information other than the information set by the occupant. However, the humidity setting and humidity display are limited to a temperature range such as 0° C. or higher where the humidity can be controlled. Plural information can be displayed on the display screen 51a at the same time. For example, information on the set temperature and the set air volume can be displayed in one display screen 51a.

The power button 57 is used for switching on/off of the air conditioner 10 by the occupant. The setting change button 58 is used for changing the set values such as the set temperature, the set air volume, and the set humidity by the occupant. The setting change button 58 includes an ascending button for increasing the set value and a descending button for decreasing the set value.

The operation panel 51 may include buttons other than the buttons described above. For example, the operation panel 51 may include a defrost button. The defrost button notifies the occupant by lighting a lamp whether or not the evaporator 15 is defrosting. The defrosting can be forcibly stopped by operating the defrost button. The defrosting can be started by the occupant operating the defrost button.

The occupant display device 59 displays the usage charge of the air conditioner 10 so that the occupant can perceive it. The method of calculating the usage charge to be displayed on the occupant display device 59 will be described later. In FIG. 4, the calculation period of the usage charge is one month from Feb. 1, 2019 to Feb. 28, 2019. Therefore, the occupant display device 59 displays the total usage charge from Feb. 1, 2019 to Feb. 28, 2019. However, the displayed charge is the current charge. If the air conditioner 10 is further used during the calculation period, the currently displayed charge will increase in real time. The occupant display device 59 provides an example of a charge display device.

The occupant display device 59 is provided adjacent to the operation panel 51. As a result, the occupant can simultaneously visually recognize the screen of the occupant display device 59 and the display screen 51a of the operation panel 51. For example, when the occupant operates the operation panel 51 to change the set temperature, the set temperature displayed on the display screen 51a and the usage charge displayed on the occupant display device 59 are visually recognized at once. The occupant display device 59 may be in the same housing as the operation panel 51.

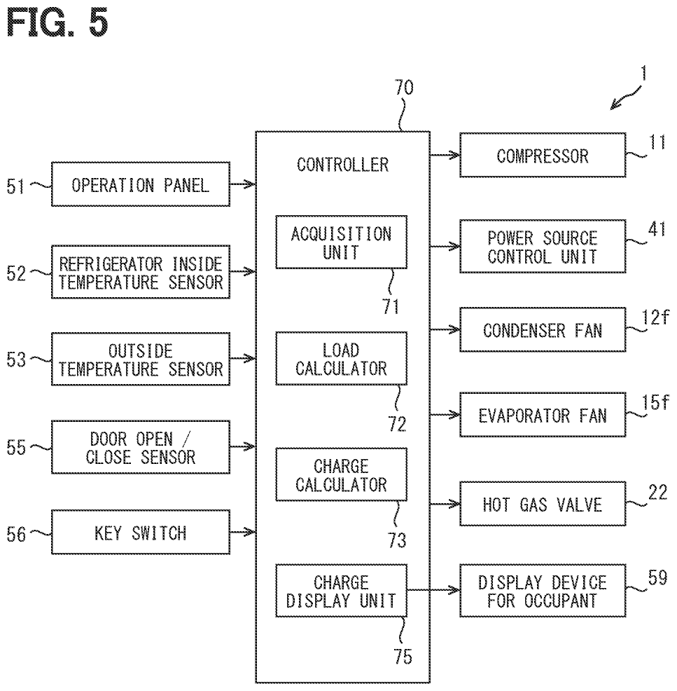

In FIG. 5, the controller 70 is connected to the operation panel 51, the refrigerator inside temperature sensor 52, and the outside temperature sensor 53. The controller 70 acquires information such as set temperature in the air conditioning operation input by the operation panel 51. The controller 70 acquires the temperature inside the refrigerator measured by the refrigerator inside temperature sensor 52. The controller 70 acquires the outside air temperature measured by the outside temperature sensor 53.

The controller 70 is connected to the door open/close sensor 55 and the key switch 56. The door open/close sensor 55 detects the open/closed state of the cold storage door 3d. The controller 70 acquires the open/closed state of the cold storage door 3d detected by the door open/close sensor 55. The controller 70 acquires the detection result of the door open/close sensor 55, for example, every 30 seconds. The key switch 56 is used for switching the state of the vehicle 2 between an ignition state, an accessory state, and an off state. The controller 70 acquires the state of the vehicle 2 switched by the key switch 56.

The controller 70 is connected to the compressor 11, the power supply control unit 41, the condenser fan 12f, the evaporator fan 15f, the hot gas valve 22, and the occupant display device 59. The controller 70 controls the drive of the compressor 11 to control the amount of the refrigerant circulating in the refrigeration cycle device 10r. The controller 70 controls the drive of the power supply control unit 41. The controller 70 controls the drive of the condenser fan 12f to control the amount of air flowing around the condenser 12. The controller 70 controls the drive of the evaporator fan 15f to control the amount of air flowing around the evaporator 15. The controller 70 controls the opening degree of the hot gas valve 22 to switch the evaporator 15 being defrosted or not. The controller 70 controls the occupant display device 59 to display the usage charge.

The controller 70 includes an acquisition unit 71, a load calculation unit 72, a charge calculation unit 73, and a charge display unit 75. The acquisition unit 71 acquires various information regarding the air conditioning operation. The acquisition unit 71 acquires, for example, the set temperature. The acquisition unit 71 acquires, for example, the temperature inside the refrigerator. The acquisition unit 71 acquires, for example, the outside air temperature. The acquisition unit 71 acquires, for example, the open/closed state of the cold storage door 3d. The acquisition unit 71 acquires, for example, whether the vehicle 2 is in the ignition state, the accessory state, or the off state.

The load calculation unit 72 calculates the amount of air conditioning load associated with the operation of the air conditioner 10. The method of calculating the air conditioning load will be described later. The charge calculation unit 73 calculates the usage charge associated with the air conditioning operation based on the amount of air conditioning load calculated by the load calculation unit 72. The charge display unit 75 controls the occupant display device 59 to display the usage charge calculated by the charge calculation unit 73.

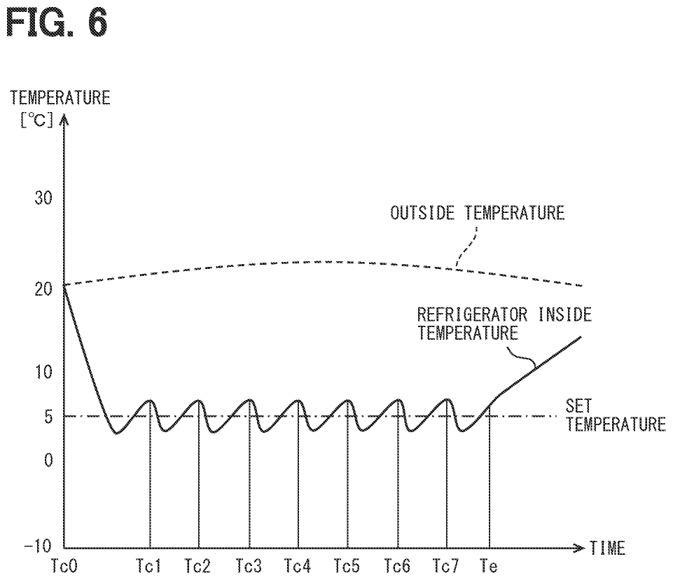

An example of the air-conditioning operation of the air conditioner 10 will be described below. FIG. 6 is a graph illustrating change in the refrigerator inside temperature over time while the air conditioning operation is performed, in which the horizontal axis represents time and the vertical axis represents temperature. The graph is shown by taking the case where the set temperature is 5° C. and the outside air temperature is about 20° C. as an example. In the graph, the refrigerator inside temperature is represented by a solid line. The outside air temperature is represented by a dashed line. The set temperature is represented by a single chain line. At Tc0, which is a timing to start the air conditioning operation, the cooling operation is started by driving the compressor 11, the condenser fan 12f, and the evaporator fan 15f. As a result, the refrigerator inside temperature, which was the temperature equivalent to the outside air temperature, decreases and gradually approaches the set temperature of 5° C. After that, by detecting that the refrigerator inside temperature has dropped to the cooling end temperature set lower than the set temperature, the drive of the compressor 11, the condenser fan 12f, and the evaporator fan 15f is stopped to stop the cooling operation. The cooling end temperature is, for example, 3° C.

While the cooling operation is stopped, the refrigerator inside temperature gradually rises due to the influence of the outside air temperature, which is higher than the refrigerator inside temperature. While the cooling operation is stopped, the evaporator 15 is defrosted as needed. After that, when it is detected that the refrigerator inside temperature has risen to the cooling start temperature set to a temperature higher than the set temperature, the cooling operation is restarted. The cooling start temperature is, for example, 7° C. After Tc0, the timing at which the cooling operation is first restarted is Tc1.

After that, the cooling operation is repeatedly executed and stopped, and the air conditioning operation is performed so that the refrigerator inside temperature falls within the temperature range from the cooling end temperature to the cooling start temperature. However, the air conditioning operation of the air conditioner 10 may be performed by inverter control that appropriately changes the rotation speed of the compressor 11 according to the cooling load. In this case, instead of repeating the execution and the stop of the cooling operation, the cooling operation is continued while adjusting the cooling capacity so that the internal temperature maintains the set temperature.

The timing at which the operation panel 51 is operated by the occupant and the power of the air conditioner 10 is turned off is Te. After the power of the air conditioner 10 is turned off, the cooling operation by the air conditioner 10 is not performed. Therefore, the temperature inside the refrigerator rises beyond the cooling start temperature, and rises to a temperature close to the outside air temperature.

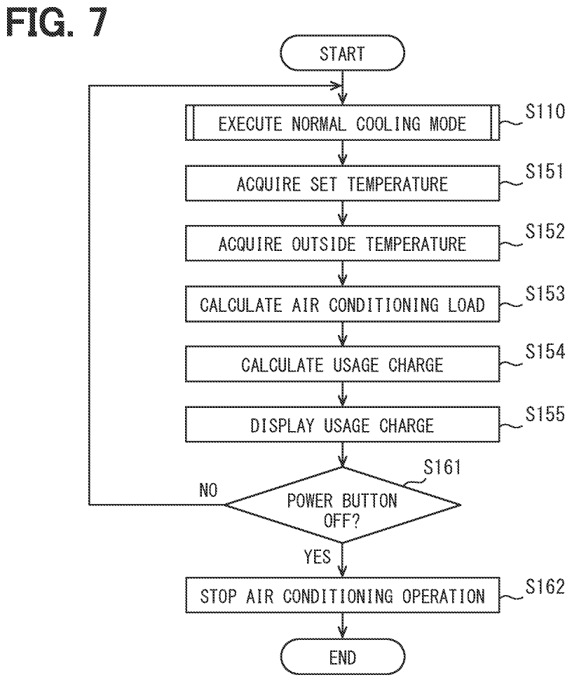

An example of control regarding the display of the usage charge of the air conditioner 10 will be described below. In FIG. 7, when the air conditioning operation is started by operating the operation panel 51 by the occupant, the normal cooling mode is executed in step S110. After executing the normal cooling mode, the process proceeds to step S151 while maintaining the air conditioning operation.

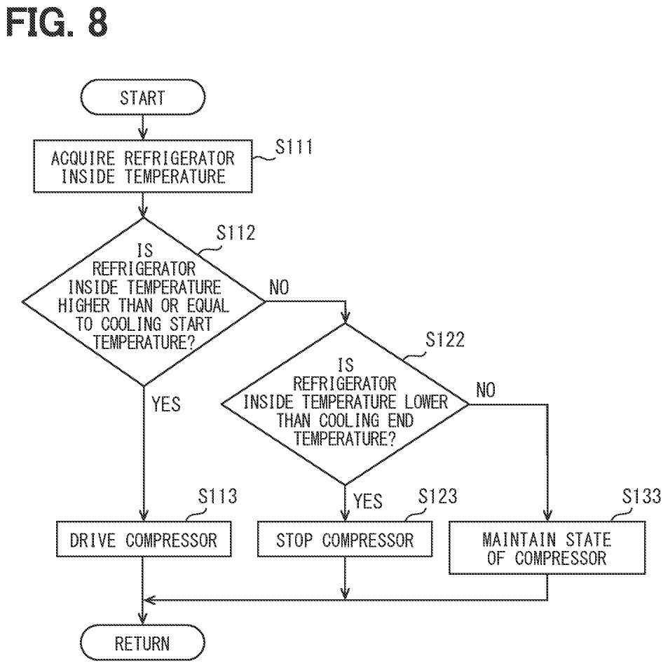

The details of the normal cooling mode will be described below. In FIG. 8, when the normal cooling mode is started, the temperature inside the refrigerator is acquired in step S111. As the temperature inside the refrigerator, the temperature measured by the refrigerator inside temperature sensor 52 is acquired. After acquiring the temperature inside the refrigerator, the process proceeds to step S112.

In step S112, it is determined whether the temperature inside the refrigerator is equal to or higher than the cooling start temperature. When the temperature inside the refrigerator is equal to or higher than the cooling start temperature, it is determined that it is necessary to cool the cold storage 3, and the process proceeds to step S113. On the other hand, when the temperature inside the refrigerator is lower than the cooling start temperature, it is determined that further determination is necessary as to whether the cold storage 3 needs to be cooled, and the process proceeds to step S122.

In step S113, the compressor 11 is driven. If the compressor 11 is in the stopped state, the compressor 11 is started to be driven. If the compressor 11 is already being driven, the state in which the compressor 11 is being driven is maintained. Along with driving the compressor 11, the condenser fan 12f is driven to facilitate the heat dissipation to the surrounding air by the condenser 12. In addition, the compressor 11 is driven and the evaporator fan 15f is driven. As a result, heat absorption from the surrounding air by the evaporator 15 is promoted, and cold air is blown into the cold storage 3. The change in control in the normal cooling mode is terminated while maintaining the state in which the compressor 11, the condenser fan 12f, and the evaporator fan 15f are driven.

In step S122, it is determined whether the refrigerator inside temperature is lower than the cooling end temperature. If the refrigerator inside temperature is lower than the cooling end temperature, it is determined that it is not necessary to cool the cold storage 3, and the process proceeds to step S123. On the other hand, if the refrigerator inside temperature is lower than the cooling end temperature, it is determined that the current state should be maintained, and the process proceeds to step S133.

In step S123, the compressor 11 is stopped. If the compressor 11 is in the driving state, the compressor 11 is made to stop. On the other hand, when the compressor 11 is already stopped, the state in which the compressor 11 is stopped is maintained. The compressor 11 is stopped and the condenser fan 12f is stopped. As a result, the heat exchange between the condenser 12 and the surrounding air is reduced. Further, the compressor 11 is stopped and the evaporator fan 15f is stopped. As a result, the heat exchange between the evaporator 15 and the surrounding air is reduced, and the cold air blown into the cold storage 3 is stopped. The state in which the compressor 11, the condenser fan 12f, and the evaporator fan 15f are stopped is maintained, and the change in control in the normal cooling mode is ended.

In step S133, the state of the compressor 11 is maintained. If the compressor 11 is in the driving state, the driving state of the compressor 11 is maintained. On the other hand, if the compressor 11 is in the stopped state, the stopped state of the compressor 11 is maintained. Further, the condenser fan 12f and the evaporator fan 15f also maintain the immediately preceding states as in the compressor 11. The compressor 11, the condenser fan 12f, and the evaporator fan 15f are maintained in the immediately preceding states, and the change in control in the normal cooling mode is ended.

In step S151 of FIG. 7, the set temperature is acquired. As the set temperature, the latest set temperature set through the operation panel 51 is acquired. After acquiring the set temperature, the process proceeds to step S152.

In step S152, the outside air temperature is acquired. As the outside air temperature, the temperature measured by the outside temperature sensor 53 is acquired. The outside air temperature is acquired at the same timing as the timing at which the set temperature is acquired. After acquiring the outside air temperature, the process proceeds to step S153.

In step S153, the air conditioning load is calculated. The air conditioning load indicates the magnitude of the load in the air conditioning operation of the air conditioner 10. For example, the higher the outside air temperature, the larger the air conditioning load in the cooling operation. Further, the lower the set temperature, the larger the air conditioning load in the cooling operation. The air conditioning load is calculated based on the outside air temperature and the set temperature. After calculating the air conditioning load, the process proceeds to step S154.

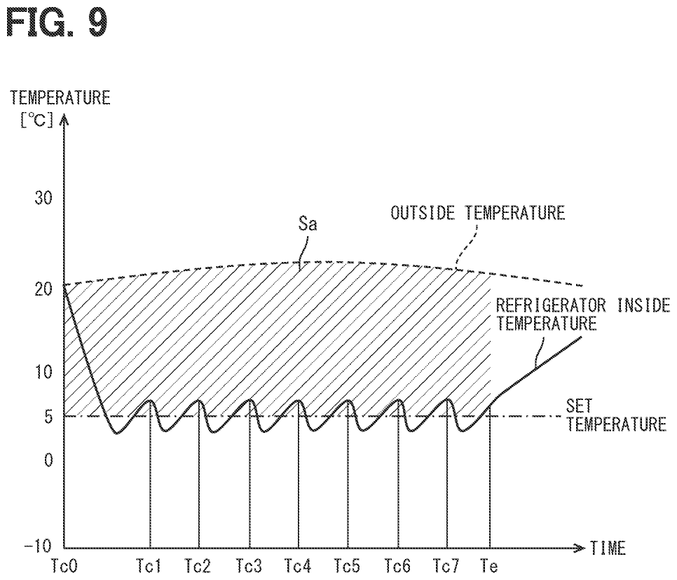

In FIG. 9, the air conditioning load can be calculated using the temperature difference by subtracting the set temperature from the outside air temperature. More specifically, the magnitude of the air conditioning load is represented by the area Sa by integrating the temperature difference obtained by subtracting the set temperature from the outside air temperature for each unit time during the time period from Tc0 when the air conditioning operation is started to Te when the air conditioning operation is finished. Since the set temperature is constant, the magnitude of the air conditioning load changes depending only on the change in the outside air temperature. If the set temperature is changed, the magnitude of the air conditioning load will change due to changes in both the outside air temperature and the set temperature. The physical quantity that should be measured using a sensor in calculating the air conditioning load is only the outside air temperature.

The larger the temperature difference obtained by subtracting the set temperature from the outside air temperature, the more heat transfers from the outside into the cold storage 3, and the longer the time for driving the air conditioner 10. Alternatively, energy such as electric power consumed when driving the air conditioner 10 tends to increase. The temperature difference obtained by subtracting the set temperature from the outside air temperature is large in summer as the outside air temperature tends to be higher than the set temperature or when the product is transported at a freezing temperature where the set temperature tends to be lower than the outside air temperature.

In step S154 of FIG. 7, the usage charge is calculated. The usage charge is calculated based on the air conditioning load. More specifically, it can be determined that the longer the time for driving the air conditioner 10 is, or the more electric power is consumed by driving the air conditioner 10, as the larger the air conditioning load is. In other words, it can be determined that the larger the air conditioning load is, the more the air conditioning management service by the air conditioner 10 is used. Therefore, the usage charge of the air conditioner 10 is calculated so that the charge increases as the air conditioning load increases. Further, the usage charge of the air conditioner 10 is calculated so that the charge decreases as the air conditioning load decreases.

The usage charge may be calculated by adding other information to the information on the air conditioning load. For example, when the air volume is set high, it is necessary to increase the rotation speed of the evaporator fan 15f. Therefore, the higher the set air volume, the higher the usage charge is. For example, when the capacity of the cold storage 3 is large, the space to be air-conditioned is large, and it is necessary to condition air for a wide space. Therefore, the larger the cold storage 3, the higher the usage charge is. After calculating the usage charge, the process proceeds to step S155.

In step S155, the usage charge is displayed. More specifically, the calculated usage charge is displayed on the occupant display device 59. If the usage charge during the calculation period is already displayed on the occupant display device 59, the usage charge will be updated to the latest usage charge. The state in which the latest usage charge is displayed on the occupant display device 59 is maintained, and the process proceeds to step S161.

In step S161, it is determined whether the power button 57 of the operation panel 51 is on or off. In other words, it is determined whether there is an air conditioning request, which is a request to continue the air conditioning operation. When the power button 57 is on, it is determined that there is an air conditioning request, and the process returns to step S110 to repeat a series of controls. As a result, the air conditioning operation is executed according to the latest internal temperature and the latest set temperature, and the latest usage charge is calculated and displayed on the occupant display device 59. When the power button 57 is off, it is determined that there is no air conditioning request, and the process proceeds to step S162.

In step S162, the air conditioning operation is stopped. More specifically, the compressor 11, the condenser fan 12f, and the evaporator fan 15f are stopped. However, the display of the usage charge on the occupant display device 59 continues. As a result, the occupant can confirm the usage charge during the calculation period even when the power button 57 is turned off and there is no air conditioning request.

According to the embodiment, the air conditioning system 1 includes the load calculation unit 72 that calculates the air conditioning load of the air conditioner 10, the charge calculation unit 73 that calculates the usage charge based on the calculated air conditioning load, and the charge display unit 75 that displays the calculated usage charge on the occupant display device 59. Therefore, the charge display unit 75 can display the usage charge based on the usage record of the air conditioner 10. Therefore, it is possible to provide the air conditioning system 1 in which a user who uses the air conditioning system 1 such as an occupant can know the usage charge according to the usage record.

Further, the usage charge of the air conditioner 10 is calculated according to the usage record. Therefore, when the air conditioner 10 is leased, the user of the air conditioner 10 can be charged a usage charge according to the usage record. In other words, instead of imposing a fixed charge, regardless of the usage record, it is possible to impose a usage charge according to the usage record. Therefore, when leasing the air conditioner 10, it is possible to increase the options for calculating the usage charge imposed on the user. In particular, when imposing a usage charge according to the usage record, the user can use the air conditioner 10 while knowing the usage charge. Therefore, the air conditioning system 1 capable of calculating the air conditioning load and the usage charge in real time and displaying the usage charge is useful when imposing the usage charge according to the usage record.

The load calculation unit 72 calculates the air conditioning load so that the larger the temperature difference obtained by subtracting the set temperature from the outside air temperature, the larger the air conditioning load. Therefore, the air conditioning load can be calculated more accurately than when the air conditioning load is calculated from the information of either the set temperature or the outside air temperature. Further, the set temperature does not need to be measured by using a sensor and can be obtained from the operation result of the operation panel 51. Therefore, it is easy to calculate the air conditioning load which is a numerical value more stable than the information that may fluctuate due to external factors such as the outside air temperature and the refrigerator inside temperature. In other words, the time required for one calculation process of the load calculation unit 72 can be shortened, and the latest air conditioning load can be calculated at short intervals.

The charge display unit 75 displays the total usage charge for a predetermined calculation period. For example, if the calculation period is set to one week, the total usage charge for one week can be easily obtained. Therefore, even when the calculation period includes the period in which the air conditioner 10 is used and the period in which the air conditioner 10 is not used, the user of the air conditioning system 1 can easily know the usage charge for the entire calculation period. Here, the charge display unit 75 may separately display the usage charge for the current day and the usage charge for the week including the current day.

The air conditioning system 1 includes the occupant display device 59 mounted on the vehicle 2 to display a usage charge for the occupant of the vehicle 2. Therefore, the occupant who can execute the operation of the air conditioning system 1 can know the usage charge in real time. Therefore, it is possible to change the set value such as the set temperature with reference to the usage charge. For example, if the usage charge is higher than expected, it is possible to give motivation to keep the usage charge low, such as trying to shorten the opening time of the cold storage door 3d while raising the set temperature within the allowable range.

The occupant display device 59 displays the calculation period and the usage charge for the calculation period on the same screen. Therefore, it is easy for the occupant to visually recognize the calculation period for the displayed usage charge.

### Second Embodiment

This embodiment is a modification based on the preceding embodiment. In this embodiment, the air conditioning load is calculated based on a temperature difference obtained by subtracting the temperature inside the refrigerator from the outside air temperature.

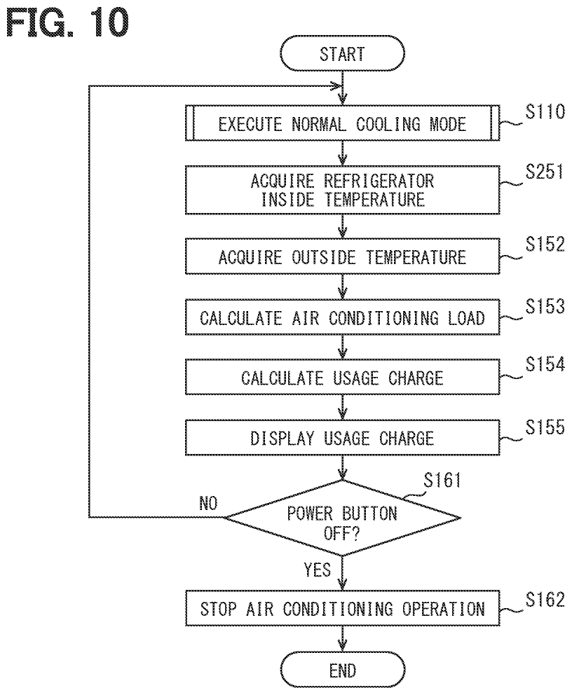

An example of control regarding the display of the usage charge of the air conditioner 10 will be described below. In FIG. 10, when the air conditioning operation is started through the operation panel 51 by the occupant, the normal cooling mode is executed in step S110. After executing the normal cooling mode, the process proceeds to step S251 while maintaining the air conditioning operation.

In step S251, the temperature inside the refrigerator is acquired by measuring with the refrigerator inside temperature sensor 52. After acquiring the temperature inside the refrigerator, the process proceeds to step S152. In step S152, the outside air temperature is acquired at the same timing as the acquisition timing of the temperature inside the refrigerator. After acquiring the outside air temperature, the process proceeds to step S153.

In step S153, the air conditioning load is calculated. The air conditioning load is calculated based on the outside air temperature and the temperature inside the refrigerator. After calculating the air conditioning load, the process proceeds to step S154.

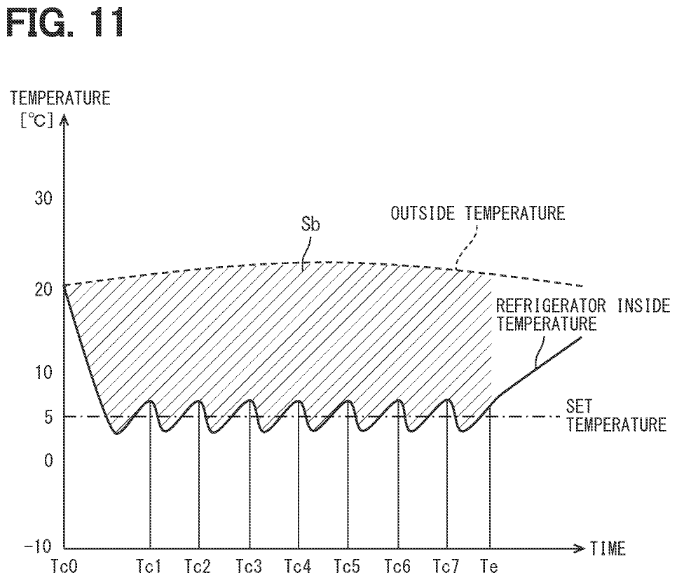

In FIG. 11, the air conditioning load can be calculated from the temperature difference obtained by subtracting the refrigerator inside temperature from the outside air temperature. More specifically, the magnitude of the air conditioning load is represented by the area Sb obtained by integrating the temperature difference by subtracting the temperature inside the refrigerator from the outside air temperature for each unit time during the time period from Tc0 when the air conditioning operation is started to Te when the air conditioning operation is finished. The magnitude of the air conditioning load is changed depending on the changes in both of the outside air temperature and the temperature inside the refrigerator.

It can be determined that the larger the temperature difference obtained by subtracting the temperature inside the refrigerator from the outside air temperature, the more energy is consumed to cool by the air conditioner 10. The temperature difference obtained by subtracting the temperature inside the refrigerator from the outside air temperature is large in summer when the outside air temperature tends to be high, in transportation at a freezing temperature where the temperature inside the refrigerator is low, or when a sufficient time elapses from the start of the operation of the air conditioner 10. The temperature difference obtained by subtracting the temperature inside the refrigerator from the outside air temperature is small during a defrosting operation since the cooling operation cannot be performed or at the timing when the cold storage door 3d is opened since the outside air easily flows into the cold storage 3.

According to the embodiment, the load calculation unit 72 calculates the air conditioning load so that the larger the temperature difference obtained by subtracting the temperature inside the refrigerator from the outside air temperature, the larger the air conditioning load. Therefore, the air conditioning load can be calculated more accurately than when the air conditioning load is calculated from the information of either the refrigerator inside temperature or the outside air temperature. Further, the temperature inside the refrigerator is a physical quantity that changes since the air conditioner 10 actually executes the cooling operation. Therefore, when the inside of the cold storage 3 cannot be cooled to the set temperature, the air conditioning load is calculated to be small. Therefore, the usage charge calculated based on the air conditioning load is also low. Therefore, the usage charge according to the operation result of the air conditioner 10 can be calculated and displayed. Further, when the cooling capacity of the air conditioner 10 is low or the degree of sealing of the cold storage 3 is low, the usage charge is calculated as lower. Therefore, it is easy to increase the user's satisfaction with the calculated usage charge. Further, a leasing company is motivated to provide the vehicle 2 provided with the air conditioner 10 having a higher cooling capacity and the cold storage 3 having a high degree of airtightness. Here, when the inside of the cold storage 3 cannot be cooled to the set temperature, it is assumed that the inside of the cold storage 3 has not been cooled to the set temperature immediately after the start of cooling or during defrosting.

### Third Embodiment

This embodiment is a modification based on the preceding embodiment. In this embodiment, the air conditioning system 1 includes an air-conditioning communication device 360 and a server 380. The air conditioning system 1 communicates with the server 380 located outside of the vehicle 2 by using the air-conditioning communication device 360 mounted on the vehicle 2 in order to acquire information for calculating the air conditioning load by this communication, so as to calculate the usage charge.

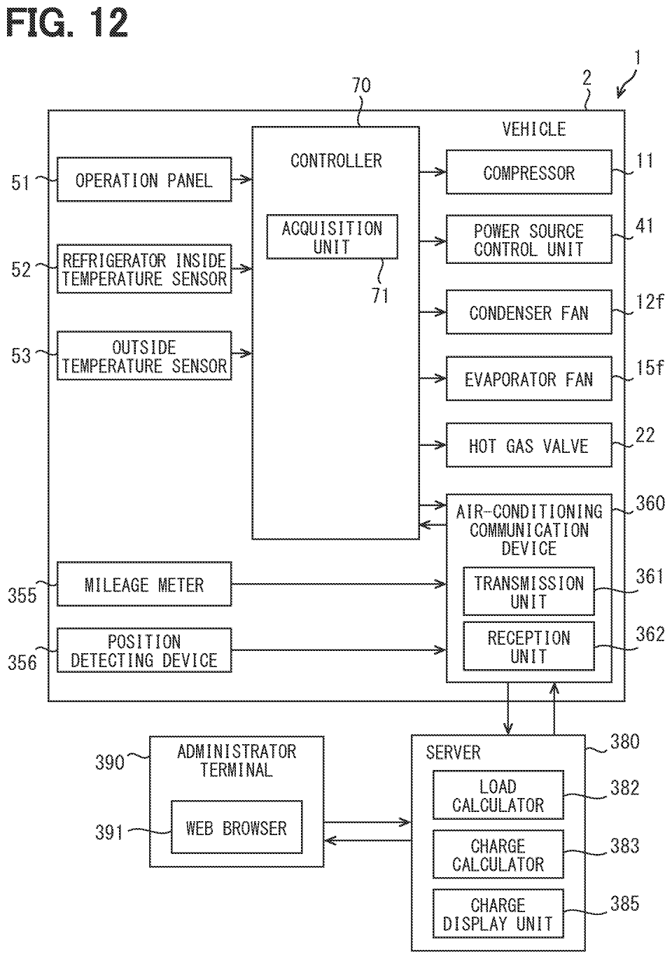

In FIG. 12, the vehicle 2 is provided with the operation panel 51, the refrigerator inside temperature sensor 52, and the outside temperature sensor 53. The vehicle 2 is provided with a mileage meter 355 and a position detecting device 356. The mileage meter 355 measures the mileage of the vehicle 2. As the mileage meter 355, for example, an odometer that integrates the mileage can be adopted. The position detecting device 356 measures the current position of the vehicle 2. The position detecting device 356 includes a GNSS receiver used for GNSS (Global Navigation Satellite System) such as GPS and GLONASS. The position detecting device 356 sequentially detects the current position of the vehicle 2 as position information based on the positioning signal received from the positioning satellite. The current position is represented by coordinates including latitude and longitude. Further, the coordinates indicating the current position may include the altitude. The vehicle 2 is provided with the compressor 11, the power supply control unit 41, the condenser fan 12f, the evaporator fan 15f, and the hot gas valve 22. In the vehicle 2, if the power button 57 is on, the normal cooling mode is executed to perform the air conditioning operation, and if the power button 57 is off, the air conditioning operation is stopped. The air conditioning load and the usage charge are not calculated in the vehicle 2.

The vehicle 2 is provided with the controller 70 and the air-conditioning communication device 360. The air-conditioning communication device 360 communicates with the server 380 provided outside the vehicle 2 about information regarding the air conditioning operation of the air conditioner 10. The air-conditioning communication device 360 includes a transmission unit 361 and a reception unit 362. The transmission unit 361 sends information on the air conditioning operation acquired from the controller 70 and information on the measurement results of the mileage meter 355 and the position detecting device 356 to the server 380 at a regular interval. The transmission interval of the transmission unit 361 is, for example, 30 seconds. The reception unit 362 receives information about the air conditioning operation from the server 380 at a regular interval. More specifically, the reception unit 362 confirms the presence/absence of a signal in the server 380. If there is a signal, the reception unit 362 transmits the received signal to the controller 70. The signal is, for example, a signal for turning off the air conditioner 10. The reception interval of the reception unit 362 is, for example, 30 seconds.

The air-conditioning communication device 360 repeatedly communicates with the server 380 at predetermined time interval in order to acquire a signal related to the air conditioning operation regardless of the presence or absence of a signal to be received. The controller 70 is connected to the air-conditioning communication device 360. The controller 70 controls the air-conditioning communication device 360 to communicate with the outside. The air-conditioning communication device 360 is a unit mounted on the vehicle 2.

The air conditioning system 1 includes the server 380 and the administrator terminal 390, which are provided outside the vehicle 2. The server 380 constitutes a part of the controller 70. The server 380 is connected to a public communication network. The server 380 acquires the information transmitted from the air-conditioning communication device 360 via the public communication network. Further, the server 380 transmits information to the air-conditioning communication device 360 via the public communication network.

The server 380 has a microcomputer including, for example, a processor, a memory, an I/O, and a bus connecting them. The server 380 executes various processes by executing the control program stored in the memory. The memory referred to here is a non-transitory tangible storage medium for storing programs and data that can be read by a computer in a non-transitory manner. The non-transitory tangible storage medium may be provided by a semiconductor memory or a magnetic disk.

The server 380 may be composed of one server device or may be composed of plural server devices. The server 380 may be a server device on the cloud.

The server 380 includes a load calculation unit 382, a charge calculation unit 383, and a charge display unit 385. The load calculation unit 382 calculates the air conditioning load based on the information acquired in the communication with the air-conditioning communication device 360. The charge calculation unit 383 calculates the usage charge based on the air conditioning load calculated by the load calculation unit 382. The charge display unit 385 outputs a signal for displaying the usage charge calculated by the charge calculation unit 383. The charge display unit 385 transmits a signal for displaying the usage charge to the administrator terminal 390 in response to an inquiry from the administrator terminal 390.

The administrator terminal 390 is connected to the server 380. The administrator terminal 390 displays the usage charge based on the signal output from the charge display unit 385 of the server 380. The administrator terminal 390 includes the WEB browser 391. The WEB browser 391 functions as a screen for displaying the usage charge for the administrator. The administrator terminal 390 provides an example of a charge display device.

The administrator terminal 390 updates the information for calculating the air conditioning load in the load calculation unit 382 of the server 380 when the administrator operates the administrator terminal 390. Further, the administrator terminal 390 updates the information for calculating the usage charge in the charge calculation unit 383 of the server 380 when the administrator operates the administrator terminal 390. For example, the information on the capacity of the cold storage 3 is updated. Alternatively, the calculation formula for calculating the usage charge according to the air conditioning load is updated. The WEB browser 391 functions as an operation screen on which the administrator can update information for calculating the air conditioning load and the usage charge.

The control regarding the display of the usage charge of the air conditioner 10 using the server 380 will be described below. When the server 380 is used to control the charge display of the air conditioner 10, the server 380 can receive a signal from the vehicle 2. In this state, when the server 380 receives the signal transmitted from the vehicle 2, the control flow regarding the charge display is started on the server 380. For example, when the air-conditioning communication device 360 transmits data every 30 seconds, the server 380 receives the data every 30 seconds. In this case, on the server 380, the control flow described later is repeatedly executed every 30 seconds based on the latest data.

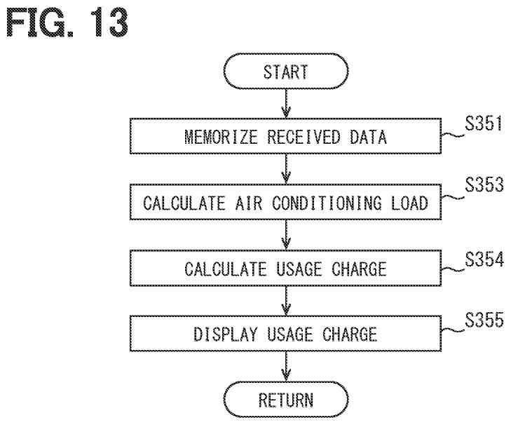

In FIG. 13, when the server 380 receives the signal transmitted from the air-conditioning communication device 360 and starts the control regarding the charge display, the received data is stored in step S351. The received data includes, for example, information on the outside air temperature. The received data includes, for example, information on the set temperature. The received data includes, for example, information on the temperature inside the refrigerator. The received data includes, for example, information on the rotation speed, the driving time, and the power consumption of the electric compressor 11a of the compressor 11. The received data includes, for example, information on the rotation speed, the driving time, and the power consumption of the condenser fan 12f and the evaporator fan 15f. The received data includes, for example, information on opening/closing the hot gas valve 22. The received data includes, for example, information on the mileage of the vehicle 2. After storing the received data, the process proceeds to step S353.

In step S353, the air conditioning load is calculated. As a method for calculating the air conditioning load, a method using the temperature difference obtained by subtracting the set temperature from the outside air temperature can be adopted. Further, as a method for calculating the air conditioning load, a method using the temperature difference obtained by subtracting the temperature inside the refrigerator from the outside air temperature may be adopted. Alternatively, the air conditioning load may be calculated using another calculation method. After calculating the air conditioning load, the process proceeds to step S354.

Another example of the method of calculating the air conditioning load will be described. When the air conditioning operation is being executed, the compressor 11, the condenser fan 12f, and the evaporator fan 15f are being driven. Therefore, the air conditioning load can be calculated according to the driving time of the compressor 11, the condenser fan 12f, and the evaporator fan 15f. For example, the air conditioning load is calculated so that the longer the compressor 11 is driven, the larger the air conditioning load is. If there is a component to be driven while the air conditioner 10 is being driven other than the compressor 11, the condenser fan 12f, and the evaporator fan 15f, the air conditioning load may be calculated from the driving time of the component.

Another example of the method of calculating the air conditioning load will be described. When the air conditioning operation is being executed, the compressor 11, the condenser fan 12f, and the evaporator fan 15f are being driven. Further, when a high cooling capacity is required as the outside air temperature is high, it is necessary to increase the rotation speed of the compressor 11, the condenser fan 12f, and the evaporator fan 15f. Therefore, the air conditioning load can be calculated according to the rotation speed of the compressor 11, the condenser fan 12f, and the evaporator fan 15f. For example, the air conditioning load is calculated so that the higher the rotation speed of the compressor 11, the larger the air conditioning load is. If there is an element that changes the cooling capacity required for the air conditioner 10 other than the rotation speed of the compressor 11, the condenser fan 12f, and the evaporator fan 15f, the air conditioning load may be calculated based on the element.

Another example of the method of calculating the air conditioning load will be described. When the air conditioning operation is being executed, the electric parts of the electric compressor 11a, the condenser fan 12f, and the evaporator fan 15f are being driven. Therefore, the air conditioning load can be calculated according to the power consumption of the electric compressor 11a, the condenser fan 12f, and the evaporator fan 15f. For example, the air conditioning load is calculated so that the larger the power consumption of the electric compressor 11a, the larger the air conditioning load is. If there are electric parts that consume electric power, other than the electric compressor 11a, the condenser fan 12f, and the evaporator fan 15f while the air conditioner 10 is driven, the air conditioning load may be calculated from the power consumption of the electric parts.

Another example of the method of calculating the air conditioning load will be described. When the air conditioning operation is being executed, the evaporator 15 is defrosted as necessary. When the set temperature is low and frost formation is likely to occur on the evaporator 15, the number of times of conducting the defrosting operation increases. Therefore, the air conditioning load can be calculated according to the number of times the defrosting is executed. For example, the air conditioning load is calculated so that the air conditioning load increases as the number of times opening the hot gas valve 22 increases.

Another example of the method of calculating the air conditioning load will be described. Assuming that the air conditioner 10 is always driven while the vehicle 2 is traveling, the drive time of the air conditioner 10 can be considered to have a correlation with the mileage of the vehicle 2. Therefore, the air conditioning load can be calculated according to the mileage measured by using the mileage meter 355 or the position detecting device 356. For example, the air conditioning load is calculated so that the longer the mileage is, the larger the air conditioning load is.

The air conditioning load is not limited to be calculated by one calculation method. For example, the air conditioning load may be determined by calculating an average value between the air conditioning load calculated using the temperature difference obtained by subtracting the set temperature from the outside air temperature and the air conditioning load calculated using the temperature difference obtained by subtracting the temperature inside the refrigerator from the outside air temperature. According to this, the air conditioning load can be calculated in consideration of many factors that change the air conditioning load such as the outside air temperature, the set temperature, and the temperature inside the refrigerator. Therefore, it is easy to accurately calculate the air conditioning load in response to various situations.

In step S354, the usage charge is calculated based on the air conditioning load. More specifically, the usage charge of the air conditioner 10 is calculated so that the charge increases as the air conditioning load increases. After calculating the usage charge, the process proceeds to step S355.

In step S355, the usage charge is displayed. More specifically, a signal is output to the administrator terminal 390, and the calculated usage charge is displayed on the WEB browser 391. If the usage charge for the calculation period is already displayed on the WEB browser 391, the usage charge will be updated to the latest usage charge. The control regarding the charge display of the air conditioner 10 using the server 380 is terminated while maintaining the state in which the latest usage charge is displayed on the WEB browser 391. However, each time a signal transmitted from the vehicle 2 is received, a series of control flows are repeated. Therefore, the usage charge displayed on the WEB browser 391 is periodically updated to the latest usage charge.

According to the embodiment, the load calculation unit 382 calculates the air conditioning load so that the longer the drive time of the compressor 11, the condenser fan 12f, and the evaporator fan 15f, the larger the air conditioning load is. Therefore, the air conditioning load can be calculated regardless of the outside air temperature. Therefore, it is possible to suppress the deviation in the calculated air conditioning load depending on the outside air temperature whose measured value changes depending on the installation position of the outside temperature sensor 53.

The drive time of the compressor 11, the condenser fan 12f, and the evaporator fan 15f can be acquired from the signal output by the controller 70. Therefore, the air conditioning load can be calculated without providing a component such as a temperature sensor to calculate the air conditioning load.

The load calculation unit 382 calculates the air conditioning load so that the air conditioning load increases as the power consumption of the electric component such as the electric compressor 11a increases. Therefore, it is easier to calculate the air conditioning load more accurately than in the case of calculating the air conditioning load based only on the driving time of the electric component.

The air conditioning system 1 includes the administrator terminal 390 provided outside the vehicle 2 to display a usage charge for an administrator who manages the vehicle 2 from the outside of the vehicle 2. Therefore, the administrator can know the usage charge of the air conditioner 10 in real time. Therefore, it is easy to control the usage charge by giving an instruction from the manager to the occupant of the vehicle 2. For example, when the occupant forgets to turn off the power button 57 after completing the transportation of the object, the administrator can promptly obtain the situation by checking the charge display and give an instruction to the occupant to turn off the power button 57.

The server 380 includes the load calculation unit 382, the charge calculation unit 383, and the charge display unit 385. Therefore, a function for calculating the air conditioning load and the usage charge and outputting a signal for displaying the usage charge can be provided outside the vehicle 2. Therefore, the calculation process related to the charge display can be performed at high speed on the server 380, and the charge display can be appropriately performed.

The air conditioning system 1 can calculate the air conditioning load for each of the vehicles 2 using the server 380 and display the charge appropriately. Therefore, it is possible to collectively grasp the usage charge for each of the vehicles 2. Further, when updating the calculation formula used for calculating the air conditioning load and the usage charge, it is not necessary to update the calculation formula for each vehicle 2. In other words, by updating the calculation formula stored in the server 380, the air conditioning load and the usage charge for each vehicle 2 can be appropriately calculated based on the updated calculation formula. Therefore, it is possible to reduce the error and the burden in the update of the calculation formula for each vehicle 2.

### Other Embodiments

The usage charge is displayed on either the occupant display device 59 or the administrator terminal 390 in the embodiment, but the usage charge may be displayed on both the occupant display device 59 and the administrator terminal 390. Alternatively, the usage charge may be displayed by using a mobile terminal of the occupant as the charge display device.

The disclosure in the specification, drawings, and the like is not limited to the illustrated embodiments. The disclosure encompasses the illustrated embodiments and variations thereof by those skilled in the art. For example, the present disclosure is not limited to the combinations of components and/or elements shown in the embodiments. The present disclosure may be implemented in various combinations. The present disclosure may have additional members which may be added to the embodiments. The disclosure encompasses omission of components and/or elements of the embodiments. The disclosure encompasses the replacement or combination of components and/or elements between one embodiment and another. The disclosed technical scope is not limited to the description of the embodiments. It should be understood that some disclosed technical ranges are indicated by description of claims, and includes every modification within the equivalent meaning and the scope of description of claims.

The disclosure in the specification, the drawings, and the like is not limited by the description of the claims. The disclosures in the specification, the drawings, and the like encompass the technical ideas described in the claims, and further extend to a wider variety of technical ideas than those in the claims. Hence, various technical ideas can be extracted from the disclosure of the specification, the drawings, and the like without being bound by the description of the claims.

The controller and method thereof according to the present disclosure may be implemented by one or more special-purposed computers. Such a special-purposed computer may be provided (i) by configuring (a) a processor and a memory programmed to execute one or more functions embodied by a computer program, or (ii) by configuring (b) a processor including one or more dedicated hardware logic circuits, or (iii) by configuring by a combination of (a) a processor and a memory programmed to execute one or more functions embodied by a computer program and (b) a processor including one or more dedicated hardware logic circuits. The technique for realizing the functions of each functional unit included in the device or the method thereof does not necessarily need to include software, and all the functions may be realized using one or more hardware circuits. The computer program may be stored in a computer-readable non-transitory tangible storage medium as an instruction executed by a computer.

What is claimed is:

1. An air conditioning system comprising:
an air conditioner mounted on a mobile body having a cold storage, the air conditioner including a compressor, a condenser, a decompression device, an evaporator, and a blower;
a charge display device configured to display a charge related to a use of the air conditioner; and
a controller configured to control an air conditioning operation, wherein the controller includes:
a load calculation unit that calculates an air conditioning load of the air conditioner;
a charge calculation unit that calculates a usage charge based on the air conditioning load; and
a charge display unit that displays the usage charge on the charge display device.

2. The air conditioning system according to claim 1, further comprising:
an outside temperature sensor configured to measure an outside air temperature which is a temperature outside of the cold storage, wherein
the load calculation unit calculates the air conditioning load to be larger as a temperature difference is larger, which is obtained by subtracting a set temperature of the air conditioner that is operating from the outside air temperature measured by the outside temperature sensor.

3. The air conditioning system according to claim 1, further comprising:
an outside temperature sensor configured to measure an outside air temperature which is a temperature outside of the cold storage; and
an internal temperature sensor that measures an internal temperature of the cold storage, wherein
the load calculation unit calculates the air conditioning load to be larger as a temperature difference is larger, which is obtained by subtracting the internal temperature measured by the internal temperature sensor from the outside air temperature measured by the outside temperature sensor.

4. The air conditioning system according to claim 1, wherein the load calculation unit calculates the air conditioning load to be larger as a time period during which the compressor or the blower is driven is longer.

5. The air conditioning system according to claim 1, wherein
the compressor or the blower is an electric component driven by receiving electric power, and
the load calculation unit calculates the air conditioning load to be larger as a power consumption of the electric component increases.

6. The air conditioning system according to claim 1, wherein the charge display unit displays a sum of the usage charge for a predetermined calculation period.

7. The air conditioning system according to claim 1, wherein
the charge display device is mounted on the mobile body, and includes an occupant display device that displays the usage charge for an occupant of the mobile body.

8. The air conditioning system according to claim 1, further comprising:
a server that is a part of the controller; and
an air-conditioning communication device mounted on the mobile body to communicate with the server, wherein
the charge display device includes an administrator terminal provided outside the mobile body, so as to display the usage charge to an administrator who manages a status of the mobile body from outside of the mobile body.
